(19) United States
(12) Patent Application Publication
(10) Pub. No.: US 2025/0139771 A1
(43) Pub. Date: May 1, 2025

(54) METHOD AND DEVICE FOR NIDUS RECOGNITION IN NEUROIMAGES, ELECTRONIC APPARATUS, AND STORAGE MEDIUM

(71) Applicant: Beijing Tiantan Hospital, Capital Medical University, Beijing (CN)

(72) Inventors: Jiajie MO, Beijing (CN); Kai ZHANG, Beijing (CN); Wenhan HU, Beijing (CN); Chao ZHANG, Beijing (CN); Xiu WANG, Beijing (CN); Baotian ZHAO, Beijing (CN); Zhihao GUO, Beijing (CN); Bowen YANG, Beijing (CN); Zilin LI, Beijing (CN); Yuan YAO, Beijing (CN)

(73) Assignee: Beijing Tiantan Hospital, Capital Medical University, Beijing (CN)

(21) Appl. No.: 18/742,299

(22) Filed: Jun. 13, 2024

Related U.S. Application Data
(63) Continuation of application No. PCT/CN2024/071337, filed on Jan. 9, 2024.

(30) Foreign Application Priority Data
Oct. 27, 2023 (CN) 202311404045.0

(51) Int. Cl. G06T 7/00; G06T 7/10; G06T 7/70; G06V 20/70

(52) U.S. Cl. CPC G06T 7/0012; G06T 7/10; G06T 7/70; G06V 20/70; G06T 2207/30016; G06V 2201/07

(57) ABSTRACT

A method and a device for nidus recognition in a neuroimage, an electronic apparatus, and a storage medium are provided. A collection of neuroimages to be recognized, including a first structural image, a first nidus image, and a first metabolic image, is determined, and then image preprocessing is performed on the collection of neuroimages to acquire a collection of object images including a second structural image, a second nidus image, and a second metabolic image. The collection of object images is input into a trained three-dimensional convolutional neural network to acquire a position of a nidus of the target object, and then the position of the nidus is labeled on the first structural image based on the position of the nidus of the target object to acquire and display an image of the position of the nidus.

### CROSS-REFERENCE TO RELATED APPLICATIONS

The present application is a continuation of International Application No. PCT/CN2024/071337, filed Jan. 9, 2024, which claims the benefit of a priority of Chinese Patent Application No. 202311404045.0, filed with the China National Intellectual Property Administration on Oct. 27, 2023. The disclosures of the aforementioned applications are hereby incorporated by reference in their entireties.

### TECHNICAL FIELD

The present disclosure relates to the field of image processing, in particular to a method and a device for nidus recognition in a neuroimage, an electronic apparatus, and a storage medium.

### BACKGROUND

Epilepsy is a sudden, recurrent and transient brain dysfunction caused by abnormal discharge activity of cerebral neurons, and is a common functional nervous system disease worldwide. However, some epileptic nidi have hidden imaging manifestations, and consequently the extent of resection is difficult to determine, which is challenging for the current clinical diagnosis and treatment. Despite the rapid development of neuroimaging technology today, some imaging changes are insidious or “negative” and are difficult to detect by conventional visual reading, resulting in a high rate of missed diagnosis. Accurate positioning of the nidus is the key to the success of surgical diagnosis and treatment. With the rapid development of computer technology, the technology of computer-assisted nidus recognition has been widely used in recent years, but it still has problems with the accuracy of the recognition results.

### SUMMARY

In view of the foregoing, the present disclosure provides a method and a device for nidus recognition in a neuroimage, an electronic apparatus, and a storage medium, which are intended to improve the accuracy of the nidus recognition results. In the present application, “neuroimage” refers to an image obtained through various techniques (such as magnetic resonance imaging, computed tomography, etc.) that visualizes and studies the brain and its neurological systems.

According to a first aspect of the present disclosure, a method for nidus recognition in a neuroimage is provided, including:
determining a collection of neuroimages to be recognized, the collection of neuroimages including a first structural image, a first nidus image, and a first metabolic image acquired by capturing images of a target object;
performing image preprocessing on the collection of neuroimages to acquire a collection of object images including a second structural image, a second nidus image, and a second metabolic image;
inputting the collection of object images into a trained three-dimensional convolutional neural network to acquire a position of a nidus of the target object; and
labeling the position of the nidus on the first structural image based on the position of the nidus of the target object to acquire and display an image of the position of the nidus.

In one possible implementation, the performing image preprocessing on the collection of neuroimages to acquire a collection of object images including a second structural image, a second nidus image, and a second metabolic image includes:
performing image segmentation on the first structural image to acquire at least one type of segmented images including a tissue of the target object;
performing image position correction on the first structural image, the first nidus image, and the first metabolic image;
extracting the target object from the first structural image, the first nidus image, and the first metabolic image after the image position correction based on the segmented images to acquire a second structural image, a second nidus image, and a second metabolic image; and
determining a collection of object images based on the second structural image, the second nidus image, and the second metabolic image.

In one possible implementation, the target object is a brain, and the segmented images include a cerebrospinal fluid image, a gray matter image, and a white matter image.

In one possible implementation, the performing image position correction on the first structural image, the first nidus image, and the first metabolic image includes:
performing anterior commissure correction, registration, and density standardization on the first structural image, the first nidus image, and the first metabolic image.

In one possible implementation, the extracting the target object from the first structural image, the first nidus image, and the first metabolic image after the image position correction based on the segmented images to acquire a second structural image, a second nidus image, and a second metabolic image includes:
determining an image mask for characterizing a position of the target object based on at least one of the segmented images; and
extracting the target object from the first structural image, the first nidus image, and the first metabolic image after the image position correction, respectively, based on the image mask to acquire the second structural image, the second nidus image, and the second metabolic image.

In one possible implementation, the convolutional neural network includes a plurality of sequentially connected convolutional layers, a fully connected layer, and an activation layer, each convolutional layer including three convolution channels corresponding to the second structural image, the second nidus image, and the second metabolic image, respectively;
the inputting the collection of object images into a trained three-dimensional convolutional neural network to acquire a position of a nidus of the target object includes:
performing parallel convolution on the second structural image, the second nidus image, and the second metabolic image in sequence based on the plurality of sequentially connected convolutional layers to acquire corresponding first feature image, second feature image, and third feature image, respectively;
inputting the first feature image, the second feature image, and the third feature image into the fully connected layer and the activation layer to acquire a probability value of a pixel position in the first feature image being the position of the nidus; and
determining the position of the nidus of the target object based on the probability value for each pixel position.

In one possible implementation, the labeling the position of the nidus on the first structural image based on the position of the nidus of the target object to acquire and display an image of the position of the nidus includes:
determining a nidus image based on the position of the nidus of the target object; and
overlapping the nidus image with the first structural image to label the position of the nidus to acquire and display the image of the position of the nidus.

According to a second aspect of the present disclosure, a device for nidus recognition in a neuroimage is provided, including:
a collection determination module configured to determine a collection of neuroimages to be recognized, the collection of neuroimages including a first structural image, a first nidus image, and a first metabolic image acquired by capturing images of a target object;
an image preprocessing module configured to perform image preprocessing on the collection of neuroimages to acquire a collection of object images including a second structural image, a second nidus image, and a second metabolic image;
a position recognition module configured to input the collection of object images into a trained three-dimensional convolutional neural network to acquire a position of a nidus of the target object; and
a position labeling module configured to label the position of the nidus on the first structural image based on the position of the nidus of the target object to acquire and display an image of the position of the nidus.

In one possible implementation, the image preprocessing module is further configured to:
perform image segmentation on the first structural image to acquire at least one type of segmented images including a tissue of the target object;
perform image position correction on the first structural image, the first nidus image, and the first metabolic image;
extract the target object from the first structural image, the first nidus image, and the first metabolic image after the image position correction based on the segmented images to acquire a second structural image, a second nidus image, and a second metabolic image; and
determine a collection of object images based on the second structural image, the second nidus image, and the second metabolic image.

In one possible implementation, the target object is a brain, and the segmented images include a cerebrospinal fluid image, a gray matter image, and a white matter image.

In one possible implementation, the image preprocessing module is further configured to:
perform anterior commissure correction, registration, and density standardization on the first structural image, the first nidus image, and the first metabolic image.

In one possible implementation, the image preprocessing module is further configured to:
determine an image mask for characterizing a position of the target object based on at least one of the segmented images; and
extract the target object from the first structural image, the first nidus image, and the first metabolic image after the image position correction, respectively, based on the image mask to acquire the second structural image, the second nidus image, and the second metabolic image.

In one possible implementation, the convolutional neural network includes a plurality of sequentially connected convolutional layers, a fully connected layer, and an activation layer, each convolutional layer including three convolution channels corresponding to the second structural image, the second nidus image, and the second metabolic image, respectively;
the position recognition module is further configured to:
perform parallel convolution on the second structural image, the second nidus image, and the second metabolic image in sequence based on the plurality of sequentially connected convolutional layers to acquire corresponding first feature image, second feature image, and third feature image, respectively;
input the first feature image, the second feature image, and the third feature image into the fully connected layer and the activation layer to acquire a probability value of a pixel position in the first feature image being the position of the nidus; and
determine the position of the nidus of the target object based on the probability value for each pixel position.

In one possible implementation, the position labeling module is further configured to:
determine a nidus image based on the position of the nidus of the target object; and
overlap the nidus image with the first structural image to label the position of the nidus to acquire and display the image of the position of the nidus.

According to a third aspect of the present disclosure, an electronic apparatus is provided, including: a processor; and a memory for storing processor executable instructions, where the processor is configured to implement the above method when executing the instructions stored in the memory.

According to a fourth aspect of the present disclosure, a non-transitory computer readable storage medium storing computer program instructions thereon is provided, where the computer program instructions, when executed by a processor, implement the above method.

According to a fifth aspect of the present disclosure, a computer program product is provided, including computer readable code, or a non-transitory computer readable storage medium carrying the computer readable code. When the computer readable code is run in a processor of an electronic apparatus, the processor of the electronic apparatus executes the above method.

In one possible implementation, a collection of neuroimages to be recognized, including a first structural image, a first nidus image, and a first metabolic image, is determined, and then image preprocessing is performed on the collection of neuroimages to acquire a collection of object images including a second structural image, a second nidus image, and a second metabolic image. The collection of object images is input into a trained three-dimensional convolutional neural network to acquire a position of a nidus of the target object, and then the position of the nidus is labeled on the first structural image based on the position of the nidus of the target object to acquire and display an image of the position of the nidus. The present disclosure accurately determines the position of the nidus in the neuroimages by preprocessing the multimodal neuroimages and detecting the nidus in the multimodal neuroimages through a neural network. Moreover, the present disclosure labels the position of the nidus on the original neuroimages directly based on the recognition results, so that the user may directly view the position of the nidus.

Other features and aspects of the present disclosure will become evident from the following detailed description of exemplary embodiments with reference to the drawings . . .

### BRIEF DESCRIPTION OF THE DRAWINGS

Together with the specification, the accompanying drawings, which are incorporated in and constitute a part of the specification, illustrate exemplary embodiments, features, and aspects of the present disclosure and serve to explain the principles of the present disclosure.

FIG. 1 shows a flowchart of a method for nidus recognition in a neuroimage according to an embodiment of the present disclosure.

FIG. 2 shows a schematic structural diagram of a convolutional neural network according to an embodiment of the present disclosure.

FIG. 3 shows a schematic diagram of a method for nidus recognition in a neuroimage according to an embodiment of the present disclosure.

FIG. 4 shows a schematic diagram of an image of a position of a nidus according to an embodiment of the present disclosure.

FIG. 5 shows a schematic diagram of a device for nidus recognition in a neuroimage according to an embodiment of the present disclosure.

FIG. 6 shows a schematic diagram of an electronic apparatus according to an embodiment of the present disclosure.

FIG. 7 shows a schematic diagram of another electronic apparatus according to an embodiment of the present disclosure.

### DETAILED DESCRIPTION

Various exemplary embodiments, features, and aspects of the present disclosure will be described in detail below with reference to the drawings. In the drawings, the same reference signs denote elements with the same or similar functions. Although various aspects of the embodiments are shown in the drawings, unless otherwise specified, the drawings are not necessarily drawn to scale.

The word “exemplary” used here means “serving as an example, embodiment or illustration”. Any embodiment described here as “exemplary” is not necessarily to be interpreted as superior to or better than other embodiments.

Furthermore, for a better explanation of the present disclosure, numerous specific details are given in the following detailed description of the embodiments. Those skilled in the art should understand that the present disclosure may also be implemented without certain specific details. In some embodiments, methods, means, elements and circuits that are well known to those skilled in the art are not described in detail in order to highlight the main idea of the present disclosure.

The method for nidus recognition in a neuroimage according to the embodiment of the present disclosure may be executed by an electronic apparatus such as a terminal device or a server, where the terminal device may be any fixed or mobile terminal, such as User Equipment (UE), a mobile device, a user terminal, a terminal, a cellular phone, a cordless telephone, a Personal Digital Assistant (PDA), a handheld device, a computing device, a vehicle-mounted device, and a wearable device, and the server may be a single server or a server cluster consisting of a plurality of servers. Any electronic apparatus may implement the method for nidus recognition in a neuroimage according to the embodiment of the present disclosure by means of a processor calling computer readable instructions stored in a memory.

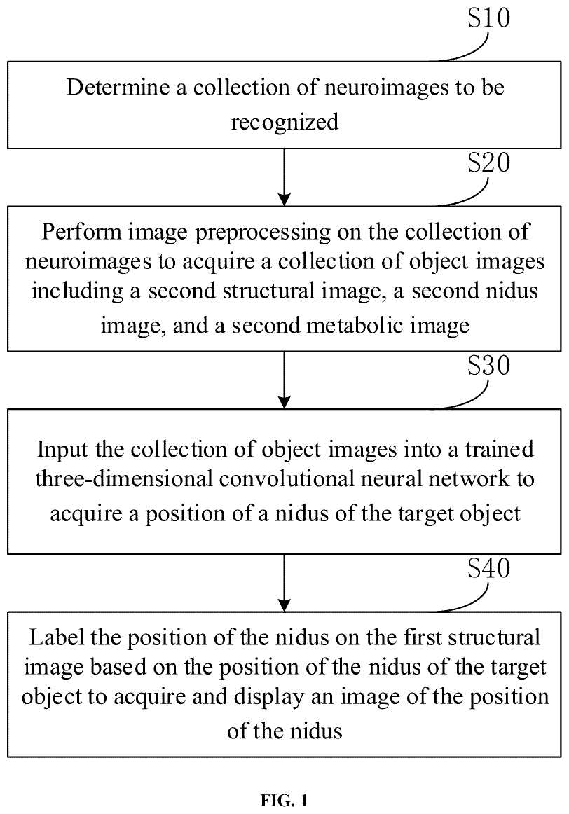

FIG. 1 shows a flowchart of a method for nidus recognition in a neuroimage according to an embodiment of the present disclosure. As shown in FIG. 1, the method for nidus recognition in a neuroimage according to the embodiment of the present disclosure may include the following steps S10-S40.

In step S10, a collection of neuroimages to be recognized is determined.

In one possible implementation, a collection of neuroimages, in which a position of a nidus needs to be recognized, is determined by an electronic apparatus. The collection of neuroimages may include a first structural image, a first nidus image, and a first metabolic image acquired by capturing images of a target object. The target object may be any human organ where a position of a nidus needs to be determined, such as the brain, heart, lungs, and liver. The electronic apparatus may acquire the collection of neuroimages directly from image acquisition of the target object by a neuroimage acquisition apparatus, or receive the collection of neuroimages acquired and transmitted by another apparatus.

Optionally, the first structural image may be TIWIMPRAGE for focusing on characterizing the anatomical structure of the target object. The first nidus image may be T2WI FLAIR for focusing on characterizing the structure of the nidus of the target object. The first metabolic image may be FDG-PET for focusing on characterizing the metabolism of the target object. Therefore, different images in the collection of neuroimages may characterize the structural features of the target object from different dimensions in a multimodal manner. Moreover, the first structural image, the first nidus image, and the first metabolic image are all three-dimensional images that may characterize the three-dimensional structure of the target object in the three-dimensional space.

In step S20, image preprocessing is performed on the collection of neuroimages to acquire a collection of object images including a second structural image, a second nidus image, and a second metabolic image.

In one possible implementation, the electronic apparatus, after determining the collection of neuroimages, performs image preprocessing on the plurality of images in the collection of neuroimages based on a predetermined image processing method to acquire the second structural image, the second nidus image, and the second metabolic image corresponding to the first structural image, the first nidus image, and the first metabolic image, respectively, in order to determine the collection of object images for characterizing the structural features of the target object.

Optionally, the image preprocessing is used for extracting the target object from the plurality of images in the collection of neuroimages, and position correction. The image preprocessing by the electronic apparatus may include performing image segmentation on the first structural image to acquire at least one type of segmented images including a tissue of the target object. Then, image position correction is performed on the first structural image, the first nidus image, and the first metabolic image. Based on the segmented images, the target object is extracted from the first structural image, the first nidus image, and the first metabolic image after the image position correction to acquire the second structural image, the second nidus image, and the second metabolic image. A collection of object images is determined based on the second structural image, the second nidus image, and the second metabolic image. The image position correction is used to align the position of the target object in the plurality of images to achieve consistency in the position of the target object in different images. The segmented images are used to extract the target object to acquire the desired information from the plurality of images, and remove other useless information from the first structural image, the first nidus image, and the first metabolic image.

Further, according to an embodiment of the present disclosure, the type of the target object may be determined first, and image segmentation is then performed based on at least one type of tissue included in the target object. By way of example, in the case where the target object is a brain, the image segmentation may involve extracting the cerebrospinal fluid portion, the gray matter portion, and the white matter portion from the first structural image, respectively, by means of the image segmentation, such that the finally acquired segmented images include a cerebrospinal fluid image, a gray matter image, and a white matter image. Optionally, the image segmentation may be implemented based on a predetermined probability graph of a pre-existing tissue of the target object.

In one possible implementation, the image position correction by the electronic apparatus may involve performing anterior commissure correction, registration, and density standardization on each of the images in the collection of neuroimages in sequence, that is, the anterior commissure correction, registration, and density standardization may be performed on the first structural image, the first nidus image, and the first metabolic image. The anterior commissure correction is used to translate and rotate each image in six directional axes based on a position of an origin in the first structural image, the first nidus image, and the first metabolic image to adjust the target object included therein to the same spatial position, with the origin being a midpoint of the anterior commissure and the posterior commissure in the brain tissue. The image registration is used to arrange the first structural image, the first nidus image, and the first metabolic image in the same predetermined spatial coordinate system. The density standardization is used to reduce the impact of a bias field, which may be achieved by any nonparametric nonuniform density standardization function.

Optionally, the sequence of the execution of the image position correction and the execution of the image segmentation in the embodiment of the present disclosure may be predetermined. For example, the image segmentation and the image position correction may be performed simultaneously or in a predetermined sequence. In the case where the image position correction and the image segmentation are performed in a predetermined sequence, the image segmentation may be interspersed in a plurality of sub-steps of the image position correction.

According to an embodiment of the present disclosure, after acquiring at least one type of segmented images by means of the image segmentation and completing the position correction of the first structural image, the first nidus image, and the first metabolic image, the electronic apparatus extracts the target object from the first structural image, the first nidus image, and the first metabolic image on the basis of the segmented images, to acquire the second structural image, the second nidus image, and the second metabolic image. Optionally, the target object in the image may be extracted by creating an image mask to remove useless information other than the target object. That is, the electronic apparatus may first determine, based on at least one segmented image, an image mask for characterizing the position of the target object, the image mask being used to characterize the position of the target object as a whole in the image or the position of each of the tissues to be retained within the target object, and then extract the target object from the first structural image, the first nidus image, and the first metabolic image after the image position correction, respectively, based on the image mask to acquire the second structural image, the second nidus image, and the second metabolic image, and then determine the collection of object images based on the second structural image, the second nidus image, and the second metabolic image.

In step S30, the collection of object images is input into a trained three-dimensional convolutional neural network to acquire the position of the nidus of the target object.

In one possible implementation, after determining the collection of object images, the electronic apparatus may input the collection of object images into a trained three-dimensional convolutional neural network, and accurately determine the position of the nidus of the target object by performing multimodal feature extraction from three dimensions through the convolutional neural network. The convolutional neural network is a three-dimensional neural network for extracting features of a three-dimensional image, which may include a plurality of sequentially connected convolutional layers, a fully connected layer, and an activation layer. Optionally, each convolutional layer in the convolutional neural network includes three convolution channels for performing convolution on the input second structural image, second nidus image, and second metabolic image, respectively.

Optionally, after the collection of object images is input into the convolutional neural network, parallel convolution may be first performed on the second structural image, the second nidus image, and the second metabolic image in sequence based on the plurality of sequentially connected convolutional layers to acquire the corresponding first feature image, second feature image, and third feature image, respectively. Then, the first feature image, the second feature image, and the third feature image are input into the fully connected layer and the activation layer to acquire a probability value of a pixel position in the first feature image being the position of the nidus, and then the position of the nidus of the target object is determined based on the probability value for each pixel position. By way of example, whether a pixel position is the position of the nidus may be determined by a predetermined probability threshold, that is, a pixel position with a probability value greater than the probability threshold may be determined as the position of the nidus, and a pixel position with a probability value smaller than the probability threshold may be determined as a nidus-free position.

Further, each three-dimensional image input into the convolutional neural network is segmented into cubes corresponding to multiple pixels, and the plurality of sequentially connected convolutional layers are configured to perform successive convolution through a plurality of filters to independently classify each pixel in the image, enabling estimation of whether the position of the pixel is the position of the nidus. Each convolutional layer may include a plurality of feature channels configured to perform convolution on each type of input cubes respectively (e.g., the cubes acquired by segmentation of the second structural image, the cubes acquired by segmentation of the second nidus image, and the cubes acquired by segmentation of the second metabolic image are input into a feature channel, respectively), extract a feature map, and input it into a channel corresponding to the next convolutional layer to carry out the feature extraction again to acquire a feature image yₗ^{m}=f(Σₙ₌₁^{c}^{ₗ₋₁}kₗ^{m,n}×yₗ₋₁ⁿ+bₗ^{m}) where 1 is the number of the current convolutional layer, m is the number of the neuron in the current convolutional layer, b^{m} is a preset bias, n is the number of the image corresponding to the channel (e.g., the second structural image, the second nidus image, and the second metabolic image are numbered 1, 2, and 3, respectively), and f is a nonlinear function with a kernel of a learned hidden weight matrix wₗ^{m,n}. Therefore, the connection kₗ=(kₗ^{m,1}, 1hkₗ^{m,C}^{ₗ₋₁}) between neighboring convolutional layers may be viewed as a four-dimensional kernel performing convolution on a convolutional object yₗ₋₁=yₗ₋₁¹, . . . , yₗ₋₁^{C}^{ₗ₋₁} in a tandem channel to ultimately acquire a first feature image, a second feature image, and a third feature image of the second structural image, the second nidus image, and the second metabolic image, where the tandem channel includes the same channels in a plurality of neighboring convolutional layers, Cₗ₋₁ being the number of channels included in each convolutional layer. A posterior probability P_{c}(x)=exp(y_{L}^{c}(x))/Σ_{c=1}^{C}^{_{L}}exp (y_{L}^{c}(x)) is further calculated through the fully connected layer and an activation function (SoftMax function), forming a soft segmentation map that includes a probability value corresponding to each pixel position. y_{L}^{c}(x) denotes the activation of a c-th classification of a channel L at a pixel position x∈N³, and C_{L} denotes a total number of the classifications of the channel L.

A receptive field is a neuron receptor in the activation layer and is considered as an impact of an input pixel neighborhood on neuron activation. The dimension of each subsequent convolutional layer is increased by a dimension φₗ, which is given by the following three-dimensional vector: φₗ^{{x,y,z}}=φₗ₋₁^{{x,y,z}}+(kₗ^{{x,y,z}}−1)τₗ^{{x,y,z}}, where (x, y, z) denotes the pixel position of the pixel in the cube, kₗ, τₗ∈N³ denote a size of the kernel and a step vector of the receptive field of a l-th layer, and τₗ is determined by a step product of a kernel function. Optionally, in order to facilitate accurate segmentation, it may be predetermined that τₗ=(1,1,1). The neuron receptor in the activation layer corresponds to an impact on a pixel position in the middle of the input cube, which may be denoted as φ_{CNN}=φ_{L}. If an input size δᵢₙ is specified in advance, the dimension of the channel in the l-th convolutional layer may be calculated by δₗ^{{x,y,z}}=└(δᵢₙ^{{x,y,z}}−φₗ^{{x,y,z}})/τₗ^{{x,y,z}}+1┘. In order to avoid the problem of overfitting, the in convolution kernel used in the convolutional layer in the embodiment of the present disclosure is a single 3³ kernel which makes it possible to perform convolution faster and which contains less weight and thus is beneficial to the segmentation of natural images. Compared with the traditional 5³ kernel, the smaller 3³ kernel saves the computing power by about 5³/3³≈4.6 times, and may also reduce the number of training parameters in the training process of the model.

Further, in order to incorporate local and larger background information into the three-dimensional convolutional neural network, the present disclosure may perform a downsampling operation on each input image, and then add a second path to perform convolution on the downsampled image. Such a multi-channel three-dimensional convolutional neural network may process multi-scale input images simultaneously. High-level features (e.g., position in the brain) and detailed local structural appearance features may be learned through each path, respectively. Since the normal convolutional path and the downsampled convolutional path perform convolution respectively and then jointly perform classification based on the results of the two convolutions, and are decoupled in the structure of the convolutional neural network, arbitrarily large background information may be processed by simply adjusting the downsampling coefficients. The sizes of the paths may be adjusted depending on the computing power and the task, which may require a relative adjustment of the number of filters used for downsampling. In order to maintain the ability for dense inference, the correlation between the activation spaces in the last convolutional layers of both paths should be guaranteed. In a network using only an odd number of kernel steps, a displacement of a convolutional kernel input into the receptive field by the first convolution path at normal resolution is required to be φ_{L1}, and a displacement of a convolutional kernel input into the receptive field by the second downsampled convolutional path is required to be φ_{L2}, with L1 denoting the first convolutional path and L2 denoting the second convolutional path. Therefore, the dimension of the convolution kernel in the second convolution path is required to be δ_{L2}^{{x,y,z}}=┌δ_{L1}^{{x,y,z}}/F_{D}┐, with F_{D} denoting the downsampling coefficient. From the above formula, it is determined that the input dimension of the second convolutional path is δᵢₙ₂^{{x,y,z}}=φ_{L2}^{{x,y,z}}+δ_{L2}^{{x,y,z}}−1, which may be extracted by centering on the same image position.

After acquiring the first feature image, the second feature image, and the third feature image corresponding to each input image by means of the plurality of sequentially connected convolutional layers in the convolutional neural network, the three feature images are input into the fully connected layer and the activation layer in order to predict whether or not a pixel position is the position of the nidus, and to acquire a probability value of a pixel position being the position of the nidus. The fully connected layer in the convolutional neural network according to the embodiment of the present disclosure may be a CRF model (fully connected three-dimensional conditional random field), which may model an arbitrarily large pixel neighborhood and is computationally simple.

Further, according to the embodiment of the present disclosure, during the training process, the cubes corresponding to the respective pixel positions in each input image may be divided, and a loss function of the model may be calculated based on the label corresponding to each cube and the prediction results so as to adjust the model. Optionally, the loss function used in the training process of the three-dimensional convolutional neural network may be:

$${J}_{D} ( θ ; {I}_{s} {c}_{s} ) = - \frac{1}{B \cdot V} {\sum }_{s = 1}^{B} {\sum }_{v = 1}^{V} log ( {log}_{{c}_{s}^{v}} ( {X}^{v} ) ) ,$$

where θ is a model parameter of the convolutional neural network, and Iₛ and cₛ are real labels of an s-th input cube and V pixel positions, respectively, and B is a total number of the cubes. x^{v} is a corresponding position in the convolutional layer channel.

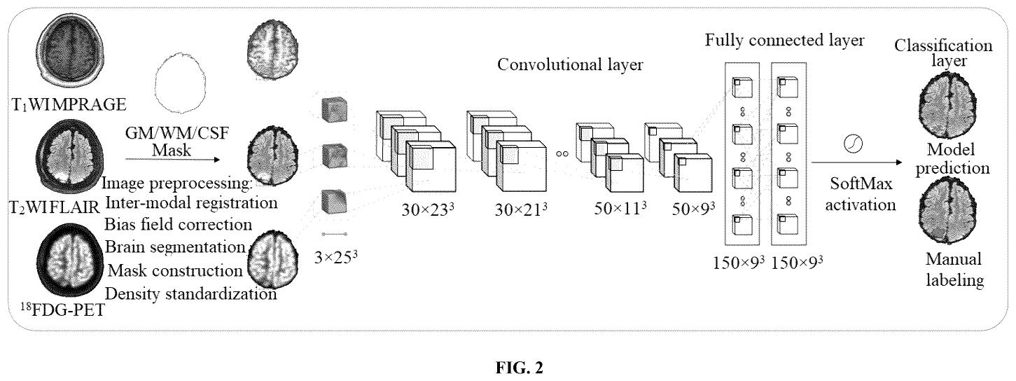

FIG. 2 shows a schematic structural diagram of a convolutional neural network according to an embodiment of the present disclosure. As shown in FIG. 2, the convolutional neural network includes a plurality of sequentially connected convolutional layers, a fully connected layer, and an activation layer. Each convolutional layer includes three convolution channels for performing convolution on the input second structural image, second nidus image, and second metabolic image, respectively. After a collection of object images is input into the convolutional neural network, parallel convolution is performed on the second structural image, the second nidus image, and the second metabolic image in sequence based on the plurality of sequentially connected convolutional layers to acquire the corresponding first feature image, second feature image, and third feature image, respectively. Then, the first feature image, the second feature image, and the third feature image are input into the fully connected layer and the activation layer to acquire a probability value of a pixel position in the first feature image being the position of the nidus, and then the position of the nidus of the target object is determined based on the probability value of each pixel position. For example, a pixel position with a probability value greater than 0.5 may be determined as the position of the nidus, and a pixel position with a probability value smaller than 0.5 may be determined as a nidus-free position.

In step S40, the position of the nidus is labeled on the first structural image based on the position of the nidus of the target object to acquire and display an image of the position of the nidus.

In one possible implementation, after the electronic apparatus performs feature extraction from different dimensions based on a trained three-dimensional convolutional neural network to recognize the position of the nidus in the target object, it may label, based on the position of the nidus in the target object, the position of the nidus on the first structural image which focuses on displaying the structure of the target object to acquire an image of the position of the nidus. The nidus image may first be determined based on the position of the nidus, and then the nidus image is overlapped with the first structural image to label the position of the nidus to thereby acquire an image of the position of the nidus and display the image to the user, so that the user may directly view the situation of the nidus in the target object.

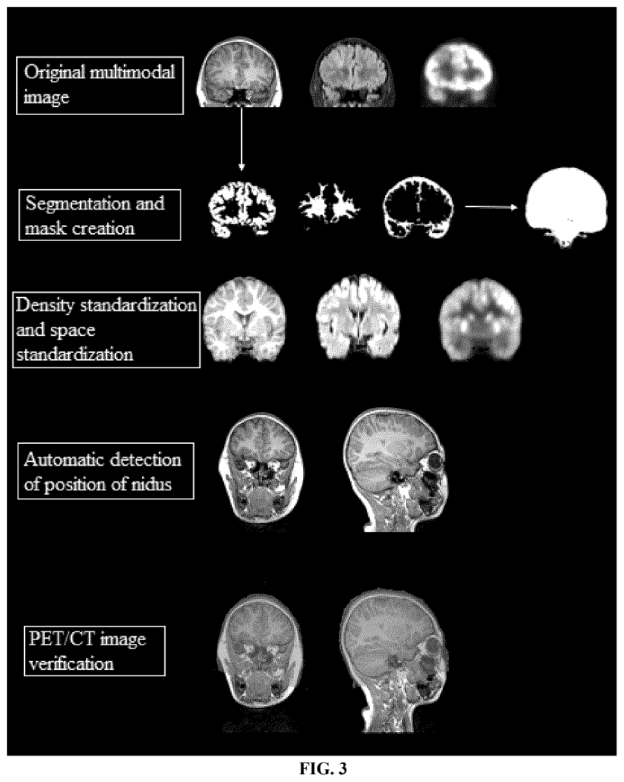

FIG. 3 shows a schematic diagram of a method for nidus recognition in a neuroimage according to an embodiment of the present disclosure. As shown in FIG. 3, according to the embodiment of the present disclosure, in the case where the target object is a brain, after capturing images of the brain to acquire a collection of neuroimages including a first structural image, a first nidus image, and a first metabolic image, the first structural image is segmented by means of image preprocessing to acquire a cerebrospinal fluid image, a gray matter image, and a white matter image, and image position correction is performed on the first structural image, the first nidus image, and the first metabolic image. A second structural image, a second nidus image, and a second metabolic image are determined based on the images acquired from the segmentation and the images on which the position correction has been performed, and are input into a three-dimensional convolutional neural network for feature extraction from the three dimensions to accurately predict the probability of a pixel position being the position of the nidus to acquire the position of the nidus and to display to the user the first structural image on which the position of the nidus is labeled.

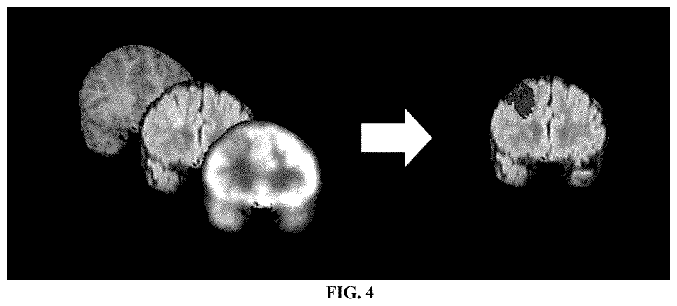

FIG. 4 shows a schematic diagram of an image of a position of a nidus according to an embodiment of the present disclosure. As shown in FIG. 4, according to the embodiment of the present disclosure, the position of the nidus is determined from different dimensions based on three different types of neuroimages, which improves the accuracy of the results of the determination. Moreover, the position of the nidus is directly labeled on the first structural image for display such that the user may directly view the situation of the nidus in the target object.

With the above technical features, the present disclosure may improve the accuracy of the results of prediction by preprocessing the multimodal neuroimages, performing position registration on the target object in the different neuroimages, retaining the information related to the position of the nidus in the target object, and removing other irrelevant interfering factors. Moreover, the features of the multimodal neuroimages are extracted by a convolutional neural network to detect the nidus and to accurately determine the position of the nidus in the neuroimages and label the position of the nidus directly on the original neuroimages, so that the user may directly view the position of the nidus.

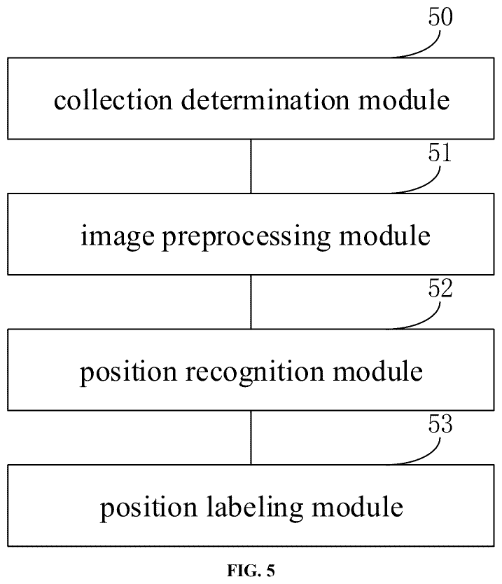

FIG. 5 shows a schematic diagram of a device for nidus recognition in a neuroimage according to an embodiment of the present disclosure. As shown in FIG. 5, according to the embodiment of the present disclosure, a device for nidus recognition in a neuroimage may include:
a collection determination module 50 configured to determine a collection of neuroimages to be recognized, the collection of neuroimages including a first structural image, a first nidus image, and a first metabolic image acquired by capturing images of a target object;
an image preprocessing module 51 configured to perform image preprocessing on the collection of neuroimages to acquire a collection of object images including a second structural image, a second nidus image, and a second metabolic image;
a position recognition module 52 configured to input the collection of object images into a trained three-dimensional convolutional neural network to acquire a position of a nidus of the target object; and
a position labeling module 53 configured to label the position of the nidus on the first structural image based on the position of the nidus of the target object to acquire and display an image of the position of the nidus.

In one possible implementation, the image preprocessing module 51 is further configured to:
perform image segmentation on the first structural image to acquire at least one type of segmented images including a tissue of the target object;
perform image position correction on the first structural image, the first nidus image, and the first metabolic image;
extract the target object from the first structural image, the first nidus image, and the first metabolic image after the image position correction based on the segmented images to acquire a second structural image, a second nidus image, and a second metabolic image; and
determine a collection of object images based on the second structural image, the second nidus image, and the second metabolic image.

In one possible implementation, the target object is a brain, and the segmented images include a cerebrospinal fluid image, a gray matter image, and a white matter image.

In one possible implementation, the image preprocessing module 51 is further configured to:
perform anterior commissure correction, registration, and density standardization on the first structural image, the first nidus image, and the first metabolic image.

In one possible implementation, the image preprocessing module 51 is further configured to:
determine an image mask for characterizing a position of the target object based on at least one of the segmented images; and
extract the target object from the first structural image, the first nidus image, and the first metabolic image after the image position correction, respectively, based on the image mask to acquire the second structural image, the second nidus image, and the second metabolic image.

In one possible implementation, the convolutional neural network includes a plurality of sequentially connected convolutional layers, a fully connected layer, and an activation layer, each convolutional layer including three convolution channels corresponding to the second structural image, the second nidus image, and the second metabolic image, respectively;
the position recognition module 52 is further configured to:
perform parallel convolution on the second structural image, the second nidus image, and the second metabolic image in sequence based on the plurality of sequentially connected convolutional layers to acquire corresponding first feature image, second feature image, and third feature image, respectively;
input the first feature image, the second feature image, and the third feature image into the fully connected layer and the activation layer to acquire a probability value of a pixel position in the first feature image being the position of the nidus; and
determine the position of the nidus of the target object based on the probability value for each pixel position.

In one possible implementation, the position labeling module 53 is further configured to:
determine a nidus image based on the position of the nidus of the target object; and
overlap the nidus image with the first structural image to label the position of the nidus to acquire and display an image of the position of the nidus.

In some embodiments of the present disclosure, the functions of the device or the modules included in the device may be used to execute the method described in the above method embodiment, the specific implementation of which may refer to in the description of the above method embodiment, and which will not be repeated here for the sake of brevity.

An embodiment of the present disclosure further provides a computer readable storage medium having computer program instructions stored thereon, where the computer program instructions, when executed by a processor, implement the above method. The computer readable storage medium may be a transitory computer readable storage medium or a non-transitory computer readable storage medium.

An embodiment of the present disclosure further provides an electronic apparatus, including a processor; and a memory for storing processor executable instructions, where the processor is configured to implement the above method when executing the instructions stored in the memory.

An embodiment of the present disclosure further provides a computer program product, including: computer readable code, or a non-transitory computer readable storage medium carrying computer readable code, where the processor in the electronic apparatus carries out the above method when the computer readable code is run in the processor of the electronic apparatus.

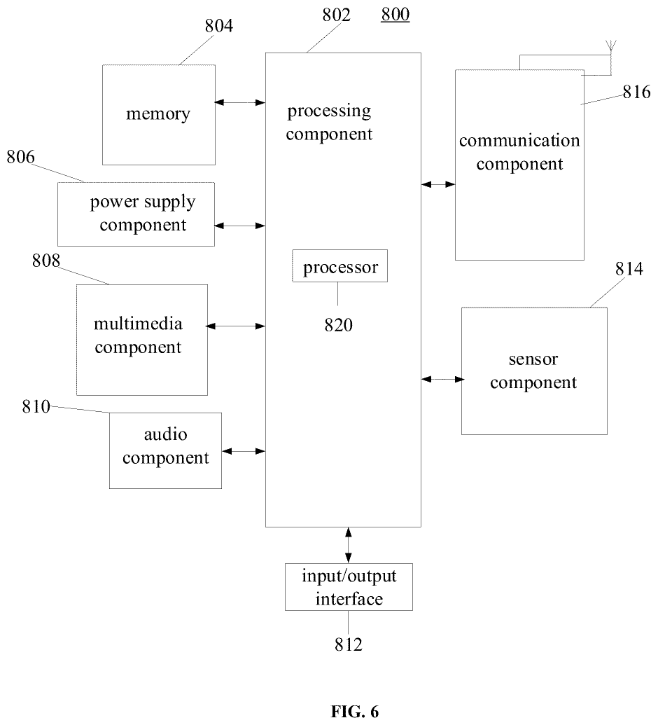

FIG. 6 shows a schematic diagram of an electronic apparatus 800 according to an embodiment of the present disclosure. For example, the electronic apparatus 800 may be a mobile phone, a computer, a digital broadcast terminal, a message transceiver, a game console, a tablet device, medical equipment, fitness equipment, a Personal Digital Assistant (PDA), or the like.

Referring to FIG. 6, the electronic apparatus 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operation of the electronic apparatus 800, such as operations related to display, phone call, data communication, camera operation, and record operation. The processing component 802 may include one or more processors 820 to execute instructions so as to complete all or some steps of the above method. Furthermore, the processing component 802 may include one or more modules to facilitate interaction between the processing component 802 and other components. For example, the processing component 802 may include a multimedia module to facilitate the interaction between the multimedia component 808 and the processing component 802.

The memory 804 is configured to store various types of data to support the operations of the electronic apparatus 800. Examples of these data include instructions for any application or method operating on the electronic apparatus 800, contact data, phonebook data, messages, pictures, videos, etc. The memory 804 may be implemented by any type of transitory or non-transitory storage apparatuses or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk, or a compact disk.

The power supply component 806 supplies electric power to various components of the electronic apparatus 800. The power supply component 806 may include a power supply management system, one or more power supplies, and other components related to the generation, management, and allocation of power for the electronic apparatus 800.

The multimedia component 808 includes a screen providing an output interface between the electronic apparatus 800 and a user. In some embodiments, the screen may include a Liquid Crystal Display (LCD) and a Touch Panel (TP). If the screen includes the touch panel, the screen may be implemented as a touch screen to receive an input signal from the user. The touch panel includes one or more touch sensors to sense the touch, sliding and gestures on the touch panel. The touch sensor may not only sense a boundary of the touch or sliding operation, but also detect the duration and pressure related to the touch or sliding operation. In some embodiments, the multimedia component 808 includes a front camera and/or a rear camera. When the electronic apparatus 800 is in an operating mode such as a shooting mode or a video mode, the front camera and/or the rear camera may receive external multimedia data. Each front camera and rear camera may be a fixed optical lens system or have a focal length and optical zooming capacity.

The audio component 810 is configured to output and/or input an audio signal. For example, the audio component 810 includes a microphone (MIC). When the electronic apparatus 800 is in the operating mode such as a call mode, a record mode, and a voice recognition mode, the microphone is configured to receive an external audio signal. The received audio signal may be further stored in the memory 804 or sent by the communication component 816. In some embodiments, the audio component 810 also includes a loudspeaker configured to output the audio signal.

The I/O interface 812 provides an interface between the processing component 802 and a peripheral interface module. The peripheral interface module may be a keyboard, a click wheel, buttons, etc. These buttons may include, but not limited to: a home button, a volume button, a start button, and a lock button.

The sensor component 814 includes one or more sensors configured to provide state evaluation in various aspects for the electronic apparatus 800. For example, the sensor component 814 may detect an on/off state of the electronic apparatus 800 and relative positions of the components such as a display and a keypad of the electronic apparatus 800. The sensor component 814 may also detect the position change of the electronic apparatus 800 or a component of the electronic apparatus 800, presence or absence of a user contact with the electronic apparatus 800, directions or acceleration/deceleration of the electronic apparatus 800, and the temperature change of the electronic apparatus 800. The sensor component 814 may include a proximity sensor configured to detect the presence of nearby objects without physical contact. The sensor component 814 may further include an optical sensor, such as a Complementary Metal Oxide Semiconductor (CMOS) or Charge Coupled Device (CCD) image sensor, for use in the imaging application. In some embodiments, the sensor component 814 may further include an acceleration sensor, a gyroscope sensor, a magnetic sensor, a pressure sensor, or a temperature sensor.

The communication component 816 is configured to facilitate the communication in a wired or wireless mode between the electronic apparatus 800 and other apparatuses. The electronic apparatus 800 may access a wireless network based on communication standards, such as wireless fidelity (Wi-Fi), a 2^{nd} generation mobile communication technology (2G), a 3^{rd} generation mobile communication technology (3G), or a combination thereof. In an exemplary embodiment, the communication component 816 receives a broadcast signal or broadcast related information from an external broadcast management system via a broadcast channel. In an exemplary embodiment, the communication component 816 further includes a Near Field Communication (NFC) module to promote the short range communication. For example, the NFC module may be implemented on the basis of a Radio Frequency Identification (RFID) technology, an Infrared Data Association (IrDA) technology, an Ultra Wide Band (UWB) technology, a Bluetooth (BT) technology and other technologies.

In an exemplary embodiment, the electronic apparatus 800 can be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electronic components, and is used to execute the above method.

In an exemplary embodiment, a non-transitory computer readable memory medium is further provided, such as the memory 804 including computer program instructions. The computer program instructions may be executed by the processor 820 of the electronic apparatus 800 to implement the above method.

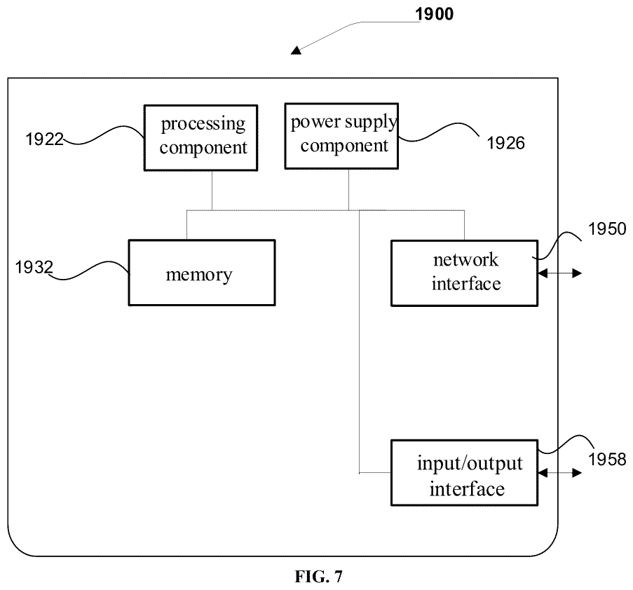

FIG. 7 shows a schematic diagram of another electronic apparatus 1900 according to an embodiment of the present disclosure. For example, the electronic apparatus 1900 may be provided as a server or a terminal device. Referring to FIG. 7, the electronic apparatus 1900 includes a processing component 1922, which further includes one or more processors, and a memory resource represented by a memory 1932 for storing instructions executable by the processing component 1922, such as application programs. The application program stored in the memory 1932 may include one or more modules each corresponding to a set of instructions. In addition, the processing component 1922 is configured to execute instructions to execute the above method.

The electronic apparatus 1900 may further include a power supply component 1926 configured to perform power management of the electronic apparatus 1900, a wired or wireless network interface 1950 configured to connect the electronic apparatus 1900 to a network, and an input/output (I/O) interface 1958. The electronic apparatus 1900 may operate based on an operating system stored in the memory 1932, such as Windows Server™, Mac OS X™, Unix™, Linux™, FreeBSD™, or the like.

In an exemplary embodiment, a non-transitory computer readable storage medium is further provided, such as the memory 1932 including computer program instructions, which may be executed by the processing component 1922 of the electronic apparatus 1900 to implement the above method.

The present disclosure may be a system, a method, and/or a computer program product. The computer program product may include a computer readable storage medium on which computer readable program instructions for causing a processor to implement various aspects of the present disclosure are stored.

The computer readable storage medium may be a tangible device that can hold and store instructions used by an instruction execution device. The computer readable storage medium may be, but not limited to, e.g., an electronic storage device, a magnetic storage device, an optical storage device, an electromagnetic storage device, a semiconductor storage device, or any suitable combination thereof. More specific examples (a non-exhaustive list) of the computer readable storage medium include a portable computer disk, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device (for example, punch-cards or raised structures in a groove having instructions stored thereon), and any suitable combination thereof. The computer readable storage medium used herein should not be construed as transitory signals per se, such as radio waves or other electromagnetic waves which propagate freely, electromagnetic waves propagating through a waveguide or other transmission media (e.g., light pulses propagating through a fiber-optic cable), or electrical signals transmitted through a wire.

Computer readable program instructions described herein may be downloaded to individual computing/processing devices from a computer readable storage medium or to an external computer or an external storage device via a network, for example, the Internet, a local area network, a wide area network and/or a wireless network. The network may include copper transmission cables, optical fiber transmission, wireless transmission, routers, firewalls, switches, gateway computers and/or edge servers. A network adapter card or a network interface in each computing/processing device receives computer readable program instructions from the network and forwards the computer readable program instructions for storage in a computer readable storage medium in the respective computing/processing devices.

Computer program instructions for carrying out the operations of the present disclosure may be assembly instructions, instruction-set-architecture (ISA) instructions, machine instructions, machine-related instructions, microcode, firmware instructions, state-setting data, or source code or object code written in any combination of one or more programming languages. The programming languages include object-oriented programming languages, such as Smalltalk, C++ or the like, and conventional procedural programming languages, such as the “C” language or similar programming languages. The computer readable program instructions may be executed entirely on a user's computer, partly on a user's computer, as a stand-alone software package, partly on a user's computer and partly on a remote computer, or entirely on a remote computer or a server. In a scenario involving a remote computer, the remote computer may be connected to the user's computer through any type of network, including a local area network (LAN) or a wide area network (WAN), or connected to an external computer (for example, using an Internet Service Provider to connect through the Internet). In some embodiments, electronic circuitry, such as programmable logic circuitry, field-programmable gate arrays (FPGA), or programmable logic arrays (PLA), may be customized by using state information of the computer readable program instructions; and the electronic circuitry may execute the computer readable program instructions, so as to achieve various aspects of the present disclosure.

Aspects of the present disclosure have been described herein with reference to the flowcharts and/or the block diagrams of methods, devices (systems), and computer program products according to the embodiments of the present disclosure. It will be appreciated that each block in the flowcharts and/or the block diagrams, and combinations of blocks in the flowcharts and/or block diagrams, can be implemented by the computer readable program instructions.

These computer readable program instructions may be provided to a processor of a general purpose computer, a special purpose computer, or other programmable data processing devices, to form a machine, such that when the instructions are executed by the processor of the computer or other programmable data processing devices, the machine implements the functions/actions specified in one or more blocks in the flowcharts and/or block diagrams. These computer readable program instructions may also be stored in a computer readable storage medium, and the instructions cause the computer, programmable data processing devices and/or other devices to function in a particular manner, such that the computer readable storage medium having instructions stored thereon includes an article of manufacture that includes instructions implementing aspects of the functions/actions specified in one or more blocks in the flowcharts and/or block diagrams.

The computer readable program instructions may also be loaded into a computer, other programmable data processing devices, or other devices to cause a series of operational steps to be executed on the computer, other programmable devices, or other devices, so as to produce a computer implemented process, such that the instructions executed on the computer, other programmable devices, or other devices implement the functions/actions specified in one or more blocks in the flowcharts and/or block diagrams.

The flowcharts and block diagrams in the drawings illustrate the architecture, functionality, and operation of possible implementations of systems, methods and computer program products according to the various embodiments of the present disclosure. In this regard, each block in the flowchart or block diagram may represent a module, program segment, or part of instructions, and the module, program segment, or part of instructions includes one or more executable instructions for implementing the specified logical function(s). In some alternative implementations, the functions denoted in the blocks may occur in an order different from that denoted in the drawings. For example, two consecutive blocks may, in fact, be executed substantially in parallel, or sometimes they may be executed in a reverse order, depending upon the functions involved. It should also be noted that each block in the block diagrams and/or flowcharts, and combinations of blocks in the block diagrams and/or flowcharts, may be implemented by dedicated hardware-based systems performing the specified functions or actions, or by combinations of dedicated hardware and computer instructions.

Although the embodiments of the present disclosure have been described above, it will be appreciated that the above descriptions are merely exemplary but not exhaustive, and that the disclosed embodiments are not limiting. A number of variations and modifications, without departing from the scopes and spirits of the described embodiments, are apparent to one skilled in the art. The terms in the present disclosure are selected to provide the best explanation on the principles and practical applications of the embodiments and the technical improvements to the arts on market, or to make the embodiments described herein understandable to one skilled in the art.

What is claimed is:

1. A method for nidus recognition in a neuroimage, comprising:
determining a collection of neuroimages to be recognized, the collection of neuroimages comprising a first structural image, a first nidus image, and a first metabolic image acquired by capturing images of a target object;
performing image preprocessing on the collection of neuroimages to acquire a collection of object images comprising a second structural image, a second nidus image, and a second metabolic image;
inputting the collection of object images into a trained three-dimensional convolutional neural network to acquire a position of a nidus of the target object; and
labeling the position of the nidus on the first structural image based on the position of the nidus of the target object to acquire and display an image of the position of the nidus.

2. The method according to claim 1, wherein the performing image preprocessing on the collection of neuroimages to acquire a collection of object images comprising a second structural image, a second nidus image, and a second metabolic image comprises:
performing image segmentation on the first structural image to acquire at least one type of segmented images containing a tissue of the target object;
performing image position correction on the first structural image, the first nidus image, and the first metabolic image;
extracting the target object from the first structural image, the first nidus image, and the first metabolic image after the image position correction based on the segmented images to acquire a second structural image, a second nidus image, and a second metabolic image; and
determining the collection of object images based on the second structural image, the second nidus image, and the second metabolic image.

3. The method according to claim 2, wherein the target object is a brain, and the segmented images comprise a cerebrospinal fluid image, a gray matter image, and a white matter image.

4. The method according to claim 2, wherein the performing image position correction on the first structural image, the first nidus image, and the first metabolic image comprises:
performing anterior commissure correction, registration, and density standardization on the first structural image, the first nidus image, and the first metabolic image.

5. The method according to claim 2, wherein the extracting the target object from the first structural image, the first nidus image, and the first metabolic image after the image position correction based on the segmented images to acquire a second structural image, a second nidus image, and a second metabolic image comprises:
determining an image mask for characterizing a position of the target object based on at least one of the segmented images; and
extracting the target object from the first structural image, the first nidus image, and the first metabolic image after the image position correction, respectively, based on the image mask to acquire the second structural image, the second nidus image, and the second metabolic image.

6. The method according to claim 1, wherein the convolutional neural network comprises a plurality of sequentially connected convolutional layers, a fully connected layer, and an activation layer, each of the convolutional layers comprising three convolution channels corresponding to the second structural image, the second nidus image, and the second metabolic image, respectively;
the inputting the collection of object images into a trained three-dimensional convolutional neural network to acquire a position of a nidus of the target object comprises:
performing parallel convolution on the second structural image, the second nidus image, and the second metabolic image in sequence based on the plurality of sequentially connected convolutional layers to acquire corresponding first feature image, second feature image, and third feature image, respectively;
inputting the first feature image, the second feature image, and the third feature image into the fully connected layer and the activation layer to acquire a probability value of each pixel position in the first feature image being the position of the nidus; and
determining the position of the nidus of the target object based on the probability value for the each pixel position.

7. The method according to claim 1, wherein the labeling the position of the nidus on the first structural image based on the position of the nidus of the target object to acquire and display an image of the position of the nidus comprises:
determining a nidus image based on the position of the nidus of the target object; and
overlapping the nidus image with the first structural image to label the position of the nidus to acquire and display the image of the position of the nidus.

8. An electronic apparatus, comprising:
a processor; and
a memory for storing processor executable instructions,
wherein the processor is configured to implement a method for nidus recognition in a neuroimage when executing the instructions stored in the memory, the method comprising:
determining a collection of neuroimages to be recognized, the collection of neuroimages comprising a first structural image, a first nidus image, and a first metabolic image acquired by capturing images of a target object;
performing image preprocessing on the collection of neuroimages to acquire a collection of object images comprising a second structural image, a second nidus image, and a second metabolic image;
inputting the collection of object images into a trained three-dimensional convolutional neural network to acquire a position of a nidus of the target object; and
labeling the position of the nidus on the first structural image based on the position of the nidus of the target object to acquire and display an image of the position of the nidus.

9. A non-transitory computer readable storage medium storing computer program instructions thereon, wherein the computer program instructions, when executed by a processor, implement a method for nidus recognition in a neuroimage, the method comprising:
determining a collection of neuroimages to be recognized, the collection of neuroimages comprising a first structural image, a first nidus image, and a first metabolic image acquired by capturing images of a target object;
performing image preprocessing on the collection of neuroimages to acquire a collection of object images comprising a second structural image, a second nidus image, and a second metabolic image;
inputting the collection of object images into a trained three-dimensional convolutional neural network to acquire a position of a nidus of the target object, and
labeling the position of the nidus on the first structural image based on the position of the nidus of the target object to acquire and display an image of the position of the nidus.
